(19) United States
(12) Patent Application Publication
(10) Pub. No.: US 2011/0238512 A1
(43) Pub. Date: Sep. 29, 2011

(54) Method and Apparatus for Showroom Sales

(76) Inventors: Eric Hapaki Doty, Chandler, AZ (US); Stephen Clouse, Phoenix, AZ (US); Scott Sarver, Waddell, AZ (US)

(21) Appl. No.: 13/073,984

(22) Filed: Mar. 28, 2011

Related U.S. Application Data
(60) Provisional application No. 61/318,021, filed on Mar. 26, 2010.

(51) Int. Cl. G06Q 30/00

(52) U.S. Cl. 705/17

(57) ABSTRACT

A method and system is provided for making store sales at a location remote from a sales counter in the store. A mobile computer device is used as a point-of-sale device to scan a product bar code identifier, to display product information associated with the product identifier, to input a quantity of items to be purchased by a customer and to select a payment type for purchasing the items. The device can communicate wirelessly with a database of product, inventory, sales and customer information and can automatically select the type of wireless connection to use. The device includes a card reader to read information from a payment card and a PIN entry pad for entering a PIN when the payment card has a debit capability. The device includes a PIN pad test program to determine whether the PIN entry pad is defective.

### RELATED APPLICATION

This application claims the benefit of U.S. Provisional Application No. 61/318,021, filed Mar. 26, 2010, entitled “Method and Apparatus for Showroom Sales,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates to methods and systems for making retail sales. More particularly, it relates to a method and system for making retail sales using a portable point-of-sale device.

Retail stores, such as U-Haul centers, can experience long customer lines during peak hours to make a purchase at the sales counter. This is inconvenient for customers and can result in lost sales for the retailer. Also, it is inconvenient to sell some products at a sales counter because they are bulky or may be remotely located from the counter.

It is an object of the present invention to provide a method and apparatus for addressing these problems and for facilitating store sales at locations that are remote from a sales counter.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in this specification.

### SUMMARY

To achieve the foregoing objects, and in accordance with the purposes of the invention as embodied and broadly described in this document, there is provided a method and system for making store sales at a sales location remote from a sales counter in the store. The method includes using a mobile computer device at a location remote from the sales counter to scan a bar code identifier of a product, to display product information associated with the product identifier, to input a quantity of items to be purchased by a customer and to select a payment type for purchasing the items, wherein the payment type can be selected from the group consisting of cash and payment card. The method also includes using the mobile computer device to read payment card information from a payment card when the customer selects the card payment type, and to prompt the customer to enter a PIN with the mobile computer device when the payment card has a debit capability.

### BRIEF DESCRIPTION OF THE DRAWINGS

The accompanying drawings, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 is a functional block diagram of a preferred computer system and a network for practicing the present invention, including a retail sales management computer system and mobile computer devices functioning as portable point-of-sale devices.

FIG. 2 is a flow diagram illustrating the operation of a PIN pad test program for testing for defective PIN entry pads on the mobile computer devices of the system.

FIG. 3 is a flow diagram illustrating the operation of a connection handler program for selecting a wireless connection type for communication between the mobile computer device and the retail sales management computer system.

FIG. 4 shows an exemplary Applications Menu page displayed on the screen of the mobile computer device, from which a salesperson can launch a showroom sales application program according to the present invention.

FIG. 5 shows an exemplary New Showroom Sale page displayed on the screen of the mobile computer device for beginning the processing of a new sale using the mobile computer device.

FIG. 6 shows an exemplary In-Store page displayed on the screen of the mobile computer device for prompting a user to scan the bar code identifier of a product to be purchased in a store showroom.

FIG. 7 shows an exemplary Online Store page displayed on the screen of the mobile computer device for searching and browsing products available through the online store.

FIG. 8 shows the Online Store page displaying exemplary search results for a product category selected by a user.

FIG. 9 shows the Online Store page displaying exemplary search results for a product query made by a user.

FIG. 10 shows a Product Description page displayed on the screen of the mobile computer device for selecting items to be purchased.

FIG. 11 shows an exemplary Shopping Cart page displayed on the screen of the mobile computer device for adding a product to the customer's electronic shopping cart.

FIG. 12 shows an exemplary Shipping Options page displayed on the screen of the mobile computer device for selecting an option for shipping a product to a customer.

FIG. 13 shows an exemplary Limited Quantity On Hand page displayed on the screen of the mobile computer device for notifying a user that the number of items in stock in a store is less than the requested quantity.

FIG. 14 shows an exemplary Customer Shipping Information page displayed on the screen of the mobile computer device for entering detailed information for shipping a product to a customer.

FIG. 15 shows an exemplary Sales Summary page displayed on the screen of the mobile computer device for summarizing the sales price, shipping charges, taxes and total of the charges for a transaction.

FIG. 16 shows an exemplary Select Payment Type page displayed on the screen of the mobile computer device for selecting payment by debit/credit card or cash for in-store sales.

FIG. 17 shows an exemplary Payment Card page displayed on the screen of the mobile computer device for entering a customer's credit or debit card information.

FIG. 18 shows an exemplary Debit Prompt page displayed on the screen of the mobile computer device for prompting a customer to enter a PIN when the selected payment card is debit capable.

FIG. 19 shows an exemplary Email Prompt page displayed on the screen of the mobile computer device for prompting a sales person to enter the customer's email address.

FIG. 20 shows an exemplary email customer sales receipt for a transaction processed with the mobile computer device.

### DESCRIPTION

Reference will now be made in more detail to presently preferred embodiments of the invention. While the invention is described more fully with reference to these examples, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

According to the present invention, a mobile computer device 11 is used as a point-of-sale device to sell products and take payment from a customer on a retail showroom floor or other location that is remote from the sales counter. The mobile computer device 11 can be used by a sales person to communicate with a retail sales management system, which can include a database of product, inventory, sales, customer and other information.

According to one aspect of the invention, the mobile computer device 11 is programmed to automatically select the debit payment option over a credit payment option if a card used for payment has debit capability.

According to another aspect of the invention, the mobile computer device includes a PIN entry pad for allowing a customer to enter a debit card PIN and PIN pad test program that allows the user to determine whether a PIN entry pad is defective.

According to still another aspect of the invention, the mobile computer device 11 can use different types of wireless network connections to communicate with the retail sales management system 16 via the Internet and automatically selects which type of wireless connection to use.

Computer Network System

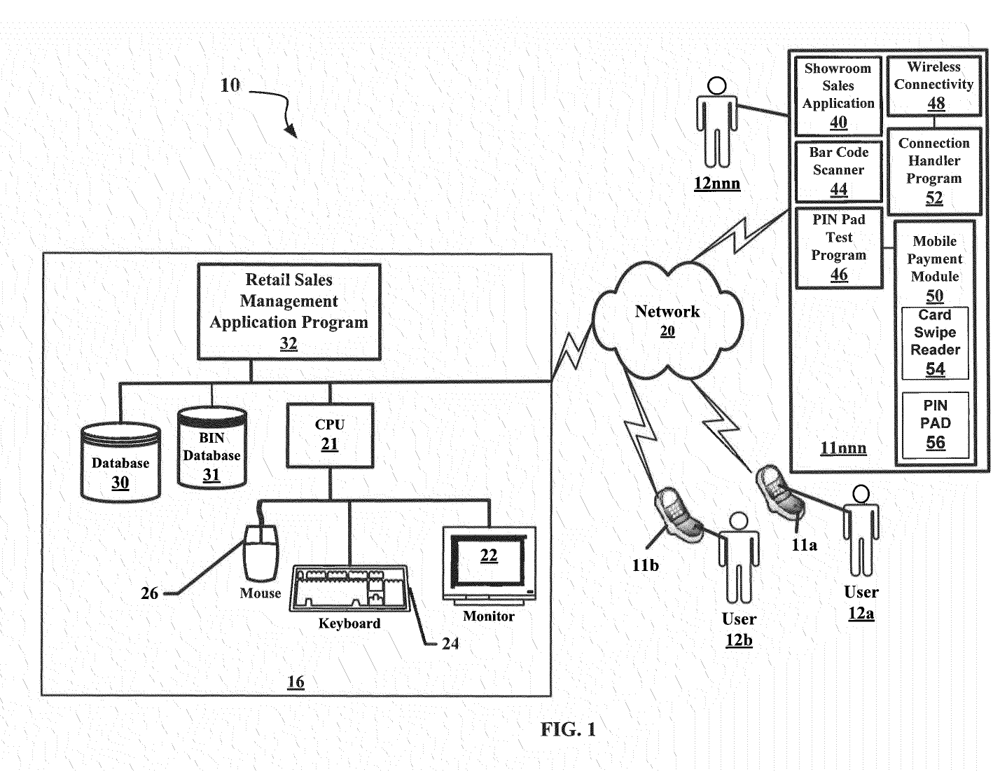

FIG. 1 illustrates a preferred computer network system 10 for practicing the present invention. The computer network system 10 includes a retail sales management computer system 16, which stores and processes the information described below for managing point-of-sale information and transactions. Mobile users 12—including showroom sales people—can access and communicate with the retail sales management computer system 16 via mobile computer devices 11a, 11b and 11nnn, (where nnn refers to any number of users and user devices) coupled to the retail sales management computer system 16 via a computer network 20, such as the Internet, or by other suitable communications means. In a preferred embodiment of the invention, the computer network 20 comprises the Internet. Upon reading this specification, those skilled in the art will understand that, under appropriate circumstances, considering issues such as developments in computer hardware, software and connectivity, etc., other network configurations and devices also may suffice.

Still referring to FIG. 1, the retail sales management computer system 16 includes a central processing unit (CPU) 21 for processing data and program instructions. The retail sales management computer system 16 also includes input and output devices, as are well known in the art. For example, the retail sales management computer system 16 preferably includes a display screen or monitor 22, a keyboard 24, a mouse 26, a printer (not shown), etc. The retail sales management computer system 16 further includes data storage and memory devices, as are known in the art, for retail sales management databases 30 and a bank identification number (BIN) database 31, which includes data for identifying whether a payment card is a debit or credit card. The retail sales management databases 30 store and retrieve information relating to stores, pricing, shipping, inventory, sales, customers, and other data required by the mobile computer device 11 to provide the functionality described more fully below.

Preferably, the databases 30, 31 are relational databases, as are well known in the art. The retail sales management computer system 16 includes a retail sales management application program 32, which is operable with the databases 30 and the mobile computer device 11 to provide the functionality described below. In a presently preferred embodiment, Web services for the retail sales management computer system 16 are provided via the .NET framework, marketed by Microsoft Corporation of Redmond, Wash. The databases 30 are implemented using the SQL Server database management system, marketed by Microsoft Corporation of Redmond, Wash. Upon reading this specification, those skilled in the art will understand that, under appropriate circumstances, considering issues such as developments in computer hardware, software and connectivity, etc., other operating systems, programming languages and database management systems can be used.

The mobile computer device 11 can store and run application programs, including a showroom sales application program 40. In a preferred embodiment, the mobile computer device 11 also includes a bar code scanner 44, wireless connectivity 48, and a mobile payment module 50 that allows for payment processing using either debit or credit cards. The mobile payment module 50 includes a credit/debit card swipe reader 54 and a PEN entry pad 56. The mobile computer device 11 also preferably includes a PIN pad test program 46 for identifying defective PIN entry pads and a connection handler program 52 for selecting the optimal wireless connection type.

One suitable mobile computer device, which can include all of these features, is the MC75 3G Worldwide Enterprise Digital Assistant device marketed by Motorola, Inc. of Schaumberg, Ill. Application programs for this device can be written in the C# programming language using Microsoft Windows Mobile development tools such as those in the Microsoft Visual Studio development environment and the software development kit available from Motorola.

The mobile computer device 12 stores and runs a mobile application manager program (not shown), which updates the application programs on the device by pulling down updates over the Internet from a mobile application management system (not shown). The mobile application manager program runs in the background on the mobile computer device 12.

PIN Pad Test Application

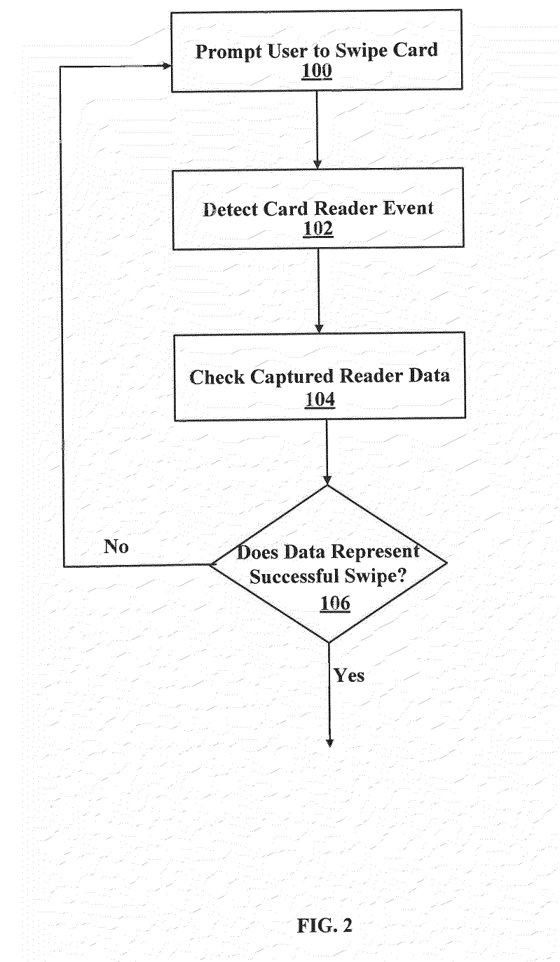

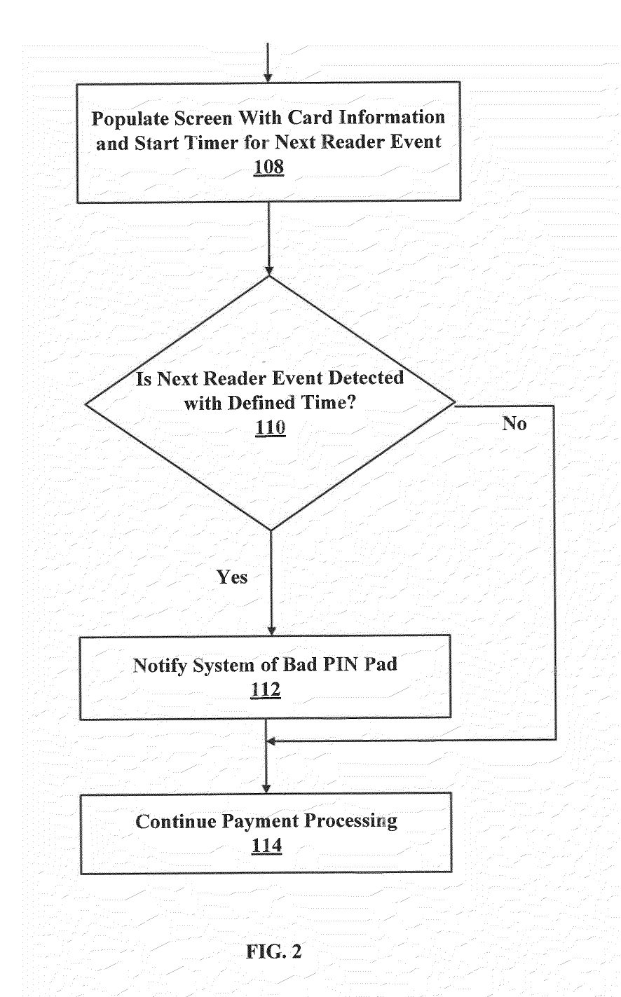

The PIN pad test program 46 allows the user to determine whether a PIN entry pad 56 is defective, thereby allowing him or her to be proactive in replacing it. Referring to FIG. 2, when a user swipes a credit or debit card (step 100), the PIN pad test program 46 detects a reader event (step 102) that is generated by the mobile payment module 50. The PIN pad test program 46 then checks the data captured by the card swipe reader (step 104) to determine whether the data reflects a successful swipe (step 106). If the swipe is not successful, the card information is not shown on the screen display of the mobile computer device 11 and the user 12 is thereby prompted to swipe the card again (step 100). If the swipe is successful, the card information is shown on the screen display of the mobile computer device 11 and a timer is started (step 108). The PIN pad test program 46 then determines whether a second reader event is detected within a defined time (step 110). Typically, the defined time is a matter of seconds. In a presently preferred method, the defined time is two seconds. If a second reader event is detected within the defined time, the mobile computer device 11 notifies the retail sales management computer system 16 that the PIN entry pad 56 is deemed defective (step 112). If a second reader event is not detected within the defined time, the PIN entry pad 56 is assumed to be non-defective. In either case, processing of the payment continues (step 114). Card authorization may be denied due to a defective PIN entry pad 56, but notification of the defective PIN entry pad facilitates quicker analysis and correction of the problem.

In one embodiment, source code for identifying a defective card reader PIN pad of the MC75 3G Worldwide Enterprise Digital Assistant device is as follows:

```
// keep track of time between card reader hardware events kicked off
private DateTime _resultStart = DateTime.MinValue;
// reader event detected
private void _symbolReader_ReadNotify(object sender, EventArgs e)
{
    // get read info
    _theReaderData = _symbolReader.GetNextReaderData( );
    // check the result of the read
    if (_theReaderData.Result = = Symbol.Results.SUCCESS)
    {
        // successful swipe -- start keeping track of time until next
        read event fired
        _resultStart = DateTime.Now;
    }
else if (_frmMain.isWaitingForPinVisible)
{
    // event fired from reader was not success and we are waiting for
    debit pin entry
    if (((TimeSpan)(DateTime.Now − _resultStart)). TotalSeconds < 2)
        {
        // if within X amount of time since initial swipe (happens almost
        immediately),
        // then we have bad debit. notify server of bad dcr.
        }
    }
}
```

Wireless Connection Handler

The mobile computer device 11 can use different types of wireless network connections to communicate with the retail sales management system via the Internet. Preferably, these connections include: (1) a wireless high-speed local area network (WLAN) connection (such as with a Wi-Fi™ wireless local area network connection): and (2) a wireless broadband connection, such as Evolution-Data Optimized (EV-DO), which is a fast wireless broadband standard that has been adopted by many CDMA mobile phone service providers. In order to use the optimal network connection, the connection handler program 52 automatically selects which type of wireless connection to use. It allows an enterprise to save money by using the WLAN connection as much as possible over the wireless broadband connection. In addition, it can be used to identify any problems where locations are not getting a good WLAN signal.

Referring to FIG. 3, when the mobile computer device 11 attempts to access the Internet (step 150) it determines if the WLAN connection is available and if it has sufficient strength (step 152). According to a preferred method, if the WLAN connection strength is at least a defined percentage, such as greater than 25%, the WLAN connection is selected over the wireless broadband connection (step 154). if the WLAN connection strength is less than the defined percentage, the wireless broadband connection is selected (step 156). After the connection type is selected, the network call is made using the selected connection type (step 158).

In a presently preferred embodiment, the connection handler program 52 is implemented for the MC75 3G Worldwide Enterprise Digital Assistant device in a single DLL for ease of development and deployment using the NET 2.0+ Framework. In order to have the mobile computer device 11 use the optimal network connection, the following method is called immediately before any network call:

MitMobileLibrary.Net.Networking.PrepareConnection( )

If a Wi-Fi™ connection is available, and the connection strength is good (preferably greater than 25%), the Wi-Fi connection will be used, and the phone will be shut off. If a Wi-Fi™ connection is not available or the strength is weak, the EVDO wireless broadband connection will be used.

The method returns a connection type that will be used as an enumeration of MitMobileLibrary.Net.Networking.ConnectionType. Here is what each return value indicates:

Unknown=0,

None=1,

Cradle=2,

WiFi=3,

EVDO=4

The method needs to be called in the main application thread, not a background thread, because it interacts with the MC75's hardware. If it is called in the background, it will cause an error to occur.

User Interface

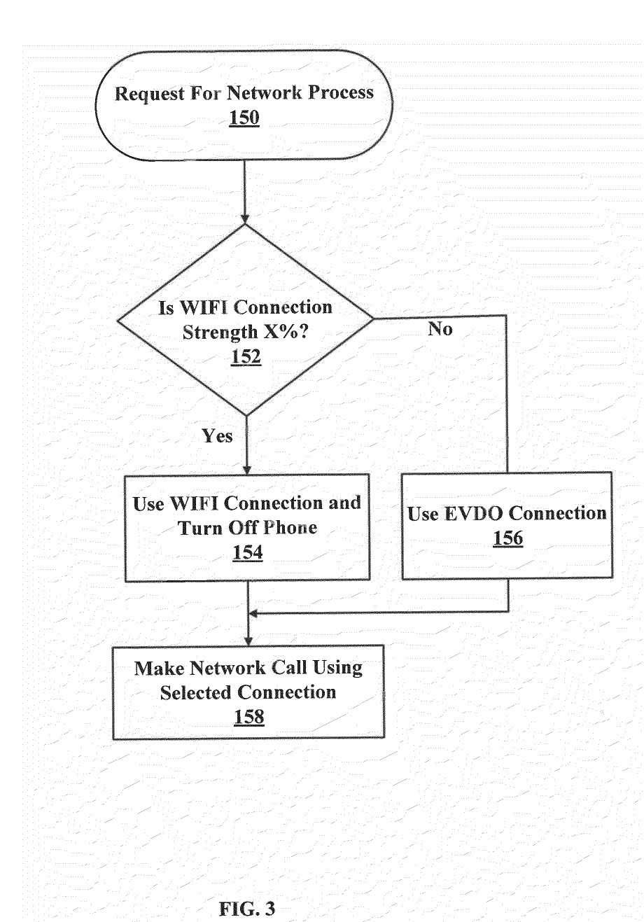

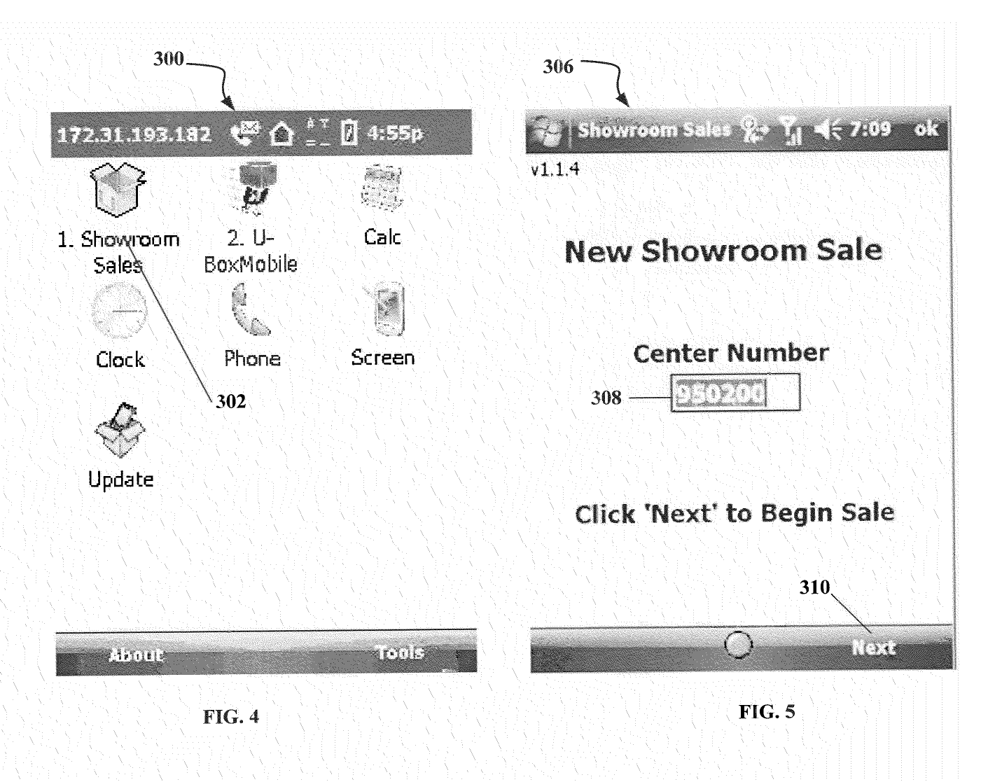

Referring to FIGS. 4 through 20, the functionality and operation of the mobile computer device 11 will now be illustrated in connection with a more detailed description of the user interface of the mobile computer device 11.

FIG. 4 shows an exemplary Applications Menu page 300 displayed on the screen of the mobile computer device 11. From this page, a user 12 (such as a showroom sales person) can launch the showroom sales application 40 by selecting a showroom sales application icon 302. In response, the mobile computer device 11 displays a New Showroom Sale page 306, such as that shown in FIG. 5. The New Showroom Sale page 306 includes a Center Number field 308 for entering a store identifier associated with the store in which the sale is being made. This allows the mobile computer device 11 to access inventory and other information from the database 30 for the specific store. After the user 12 enters their store identifier, he or she can press a Next button 310 to proceed with the sales transaction. In response, the mobile computer device 11 displays an In-Store page 312, such as that shown in FIG. 6.

Referring to FIG. 6, the In-Store page 312 includes a navigation menu 314 with an In-Store tab 316, an Online Store tab 318 and a Cart tab 320. The In-Store page 312 prompts the user 12 to use the bar code scanner 44 to scan the bar code identifier of the product to be purchased in the store. When the bar code identifier is scanned, the mobile computer device 11 will search for and display product information associated with the product identifier, a Quantity field 352 and an Add to Cart button 354 similar to that shown in FIG. 10, the operation of which is discussed below. If no bar code is available, the user 12 can select a No Bar Code button 322 and the mobile computer device 11 will display list of product categories similar to that shown in FIG. 7. From the product categories list, the user 12 can search and select available in-store products. The user 12 can select the Cart tab 320 to display a Shopping Cart page 360, which is discussed more fully below.

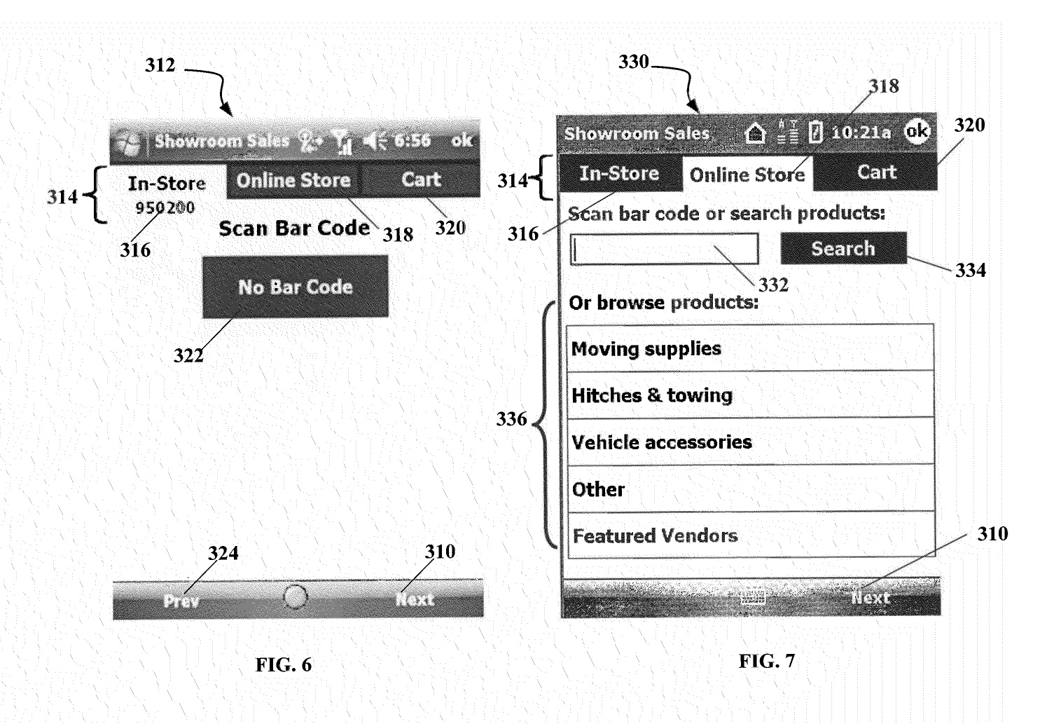

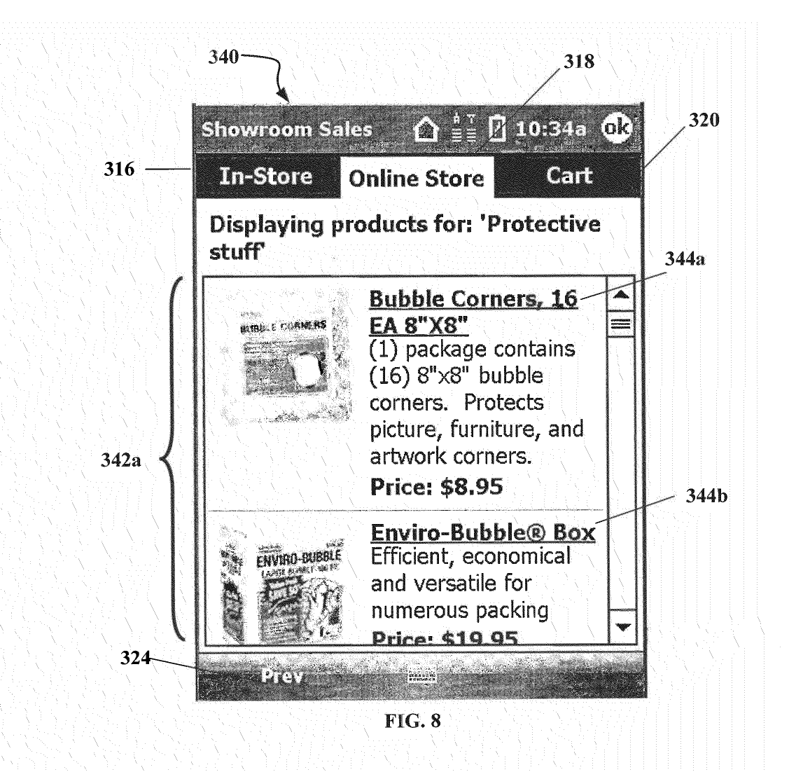

Still referring to FIG. 6, if the user 12 selects the Online Store tab 318, the mobile computer device 11 displays an Online Store page 330, such as that shown in FIG. 7, which can be used to view product information and availability for products sold online. The Online Store page 330 includes an entry field 332 and a search button 334 as well as a product categories list 336. To view online information on a product, the user 12 can browse products by selecting a product category from a product category list 336 and clicking on the Next button 310. In response, the mobile computer device 11 will communicate with the retail sales management computer system 16 to initiate a query of the product data in the database 30 and will display the results of the query as a list for products 342a in the selected category, such as the example shown in FIG. 8. The product list 342a includes product description links 344.

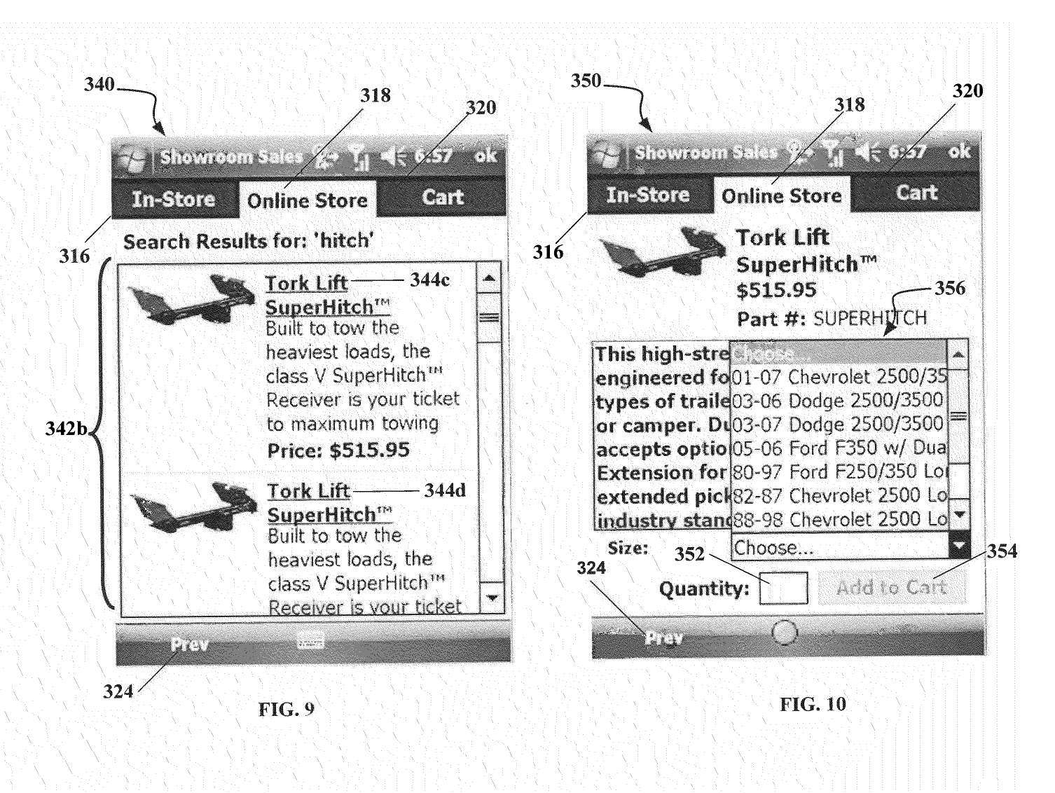

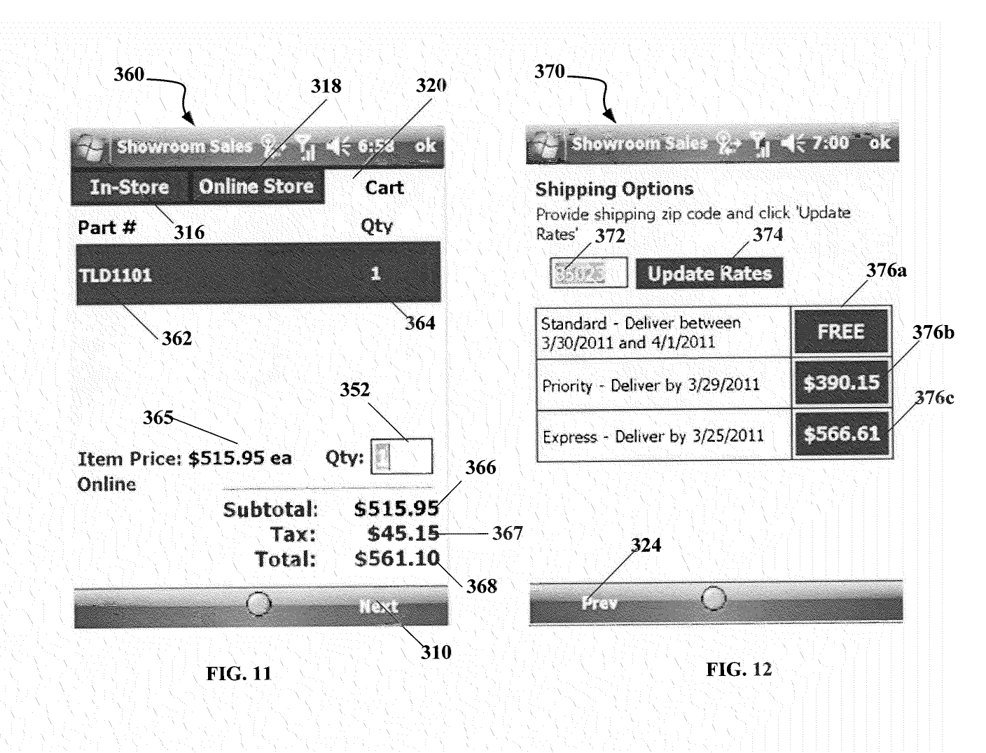

Referring back to FIG. 7, the user 12 can enter a search term into the entry field 332 and select a Search button 334 to search the database 30 for related products. For example, if the user 12 enters the term “hitch” and selects the Search button 334, the mobile computer device will communicate with the retail sales management computer system 16 to initiate a query of the product data in the database 30 and will display the results of the query as a product list 342b with product description links 344, as shown in FIG. 9. The user 12 can select a product description link 344, which will cause the mobile computer device 11 to display a Product Description page 350 like that shown in FIG. 10. The Product Description page 350 includes a Quantity field 352 for entering the quantity of units to be purchased and an Add to Cart button 354. The Product Description page 350 can include an additional drop-down menu 356 for choosing further product selection details, as shown in FIG. 10. After entering the quantity of units to be purchased in the Quantity field 352, the user 12 can select the Add to Cart button 354 to cause the mobile computer device 11 to display a Shopping Cart page 360, as shown in FIG. 11.

As shown in FIG. 11, the Shopping Cart page 360 displays the Part Number 362, Quantity 364 and Item Price 365 of each item currently included in an order being processed, as well as a Subtotal amount 366, a Tax amount 367 and a Total amount 368 for all of the items in the order. The user 12 can change the quantity of a selected item by entering a different quantity into the Quantity field 352. Additional items can be added to the order by selecting the In-Store tab 316 or the Online Store tab 318 and repeating the process described above. When the order in process includes all desired items, the user 12 can select the Next button 310 to proceed with the transaction. For a sale of items that are all in store (which does not require shipping), the mobile computer device 11 will display a Select Payment Type page 420 as shown in FIG. 16.

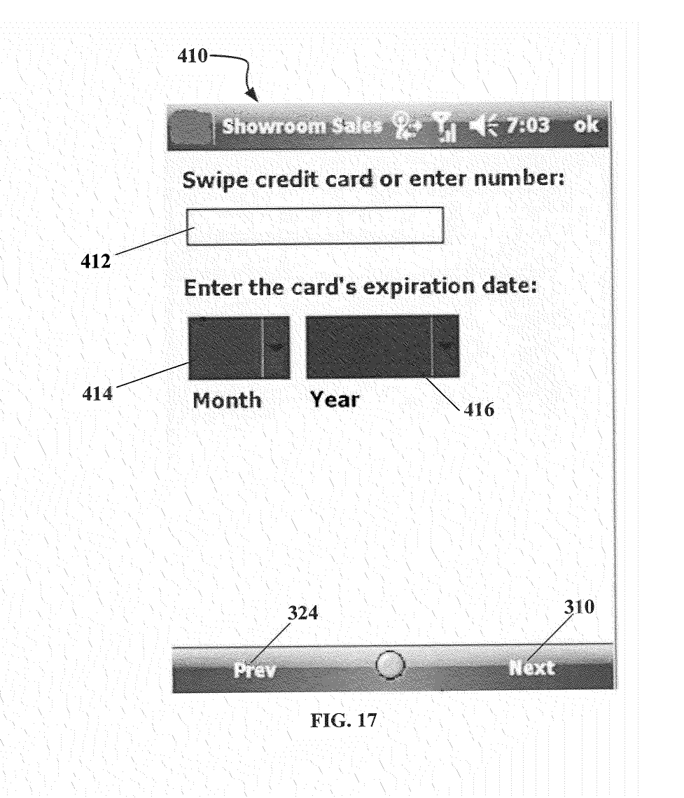

If the items for the order are to be shipped (such as when they are ordered via the Online Store page 330), the mobile computer device 11 will display a Shipping Options page 370, like the example shown in FIG. 12. As shown in FIG. 12, the Shipping Options page 370 includes a Zip Code entry field 372, an Update Rates button 374 and shipping option buttons 376 for selecting a desired shipping method. To calculate shipping charges, the user enters the zip code of the shipping destination into the Zip Code entry field 372 and selects the Update Rates button 374. In response, the mobile computer device 11 communicates with the retail sales management computer system 16 to obtain the charges for the various shipping options and returns that information to the mobile computer device 11. As shown in FIG. 12, the system can be programmed to provide the customer with a free shipping option, such as for standard delivery. When the user 12 selects a shipping option button 376, the mobile computer device 11 displays a Customer Shipping Information page 390, like that shown in FIG. 14, for entering the customer's detailed contact and shipping information. After the shipping information is entered into the Shipping Information page 390, the user can select the Next button 310 and the mobile computer device 11 will display a Payment Card page 410 for entering a customer's credit or debit card information, such as the page shown in FIG. 17.

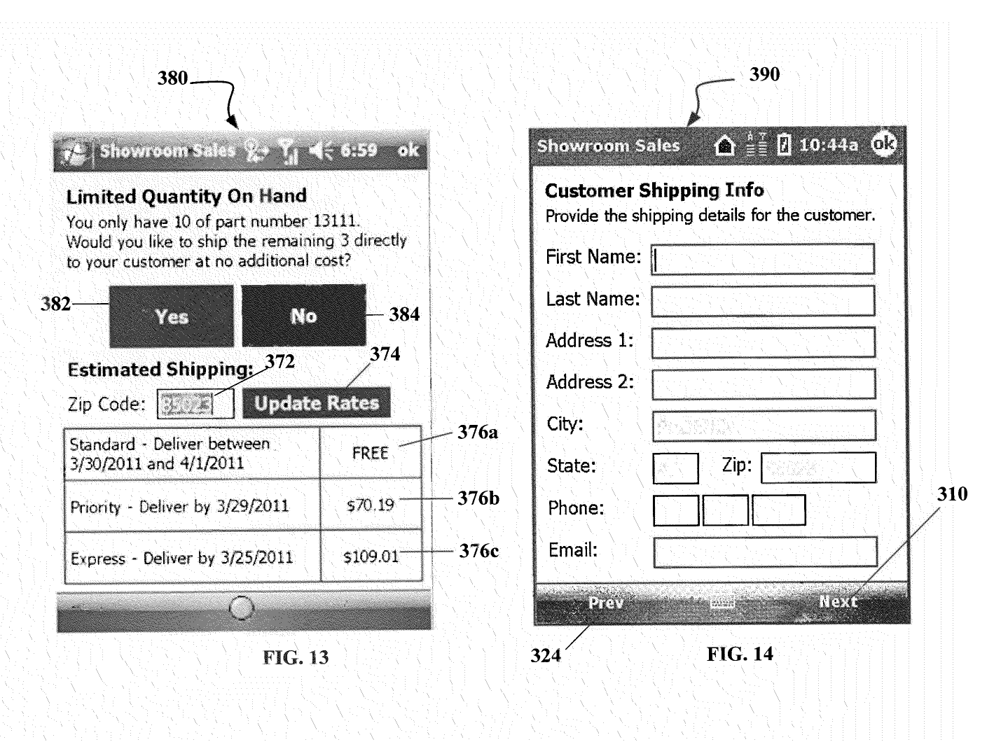

Referring back to FIG. 11, if the in-store stock of the selected item is less than the quantity entered into the Quantity field 352, the mobile computer device 11 will display a Limited Quantity On Hand page 380, like the example shown in FIG. 13. The Limited Quantity On Hand page 380 notifies the user 12 that the number of units in stock is less than the requested quantity and asks if the user 12 would like to have the balance of the units shipped to the customer. The user 12 can respond by selecting a Yes button 382 or a No button 384. If the Yes button 382 is selected, the user 12 can then update and select a desired shipping option as previously described. If the user 12 selects the No button 384, no shipping option is presented.

Referring to FIG. 16, for in-store sales (which do not require shipping), the Select Payment Type page 420 includes a Credit Card button 422 and a Cash button 424. (For transactions that require shipping, payment can only be by debit or credit card and the Select Payment Type page 420 is not displayed.) If the customer wishes to pay with cash for an in-store sale, the user 12 selects the Cash button 424 and the mobile computer device 11 sends the order information to retail sales management computer system 16 from which it can be accessed by an in-store cash register (not shown). The customer can then pay for the transaction at the cash register. If the customer wishes to pay with a credit or debit card, the user 12 selects the Credit Card button 422 and the mobile computer device 11 displays a Payment Card page 410 for entering a customer's credit or debit card information, such as the page shown in FIG. 17.

Referring to FIG. 17, the Payment Card page 410 prompts the user 12 to swipe the card using the card swipe reader 54 of the mobile computer device 11 or manually enter the card number into a card number field 412. The Payment Card page 410 also includes drop down fields for entering a card's expiration month 141 and year 416. After the card information is entered, the user can select the Next button 310 to proceed. If the card is swiped, the card number field 412, expiration month field 141 and expiration year field 416 are automatically populated from the information read by the card swipe reader 54.

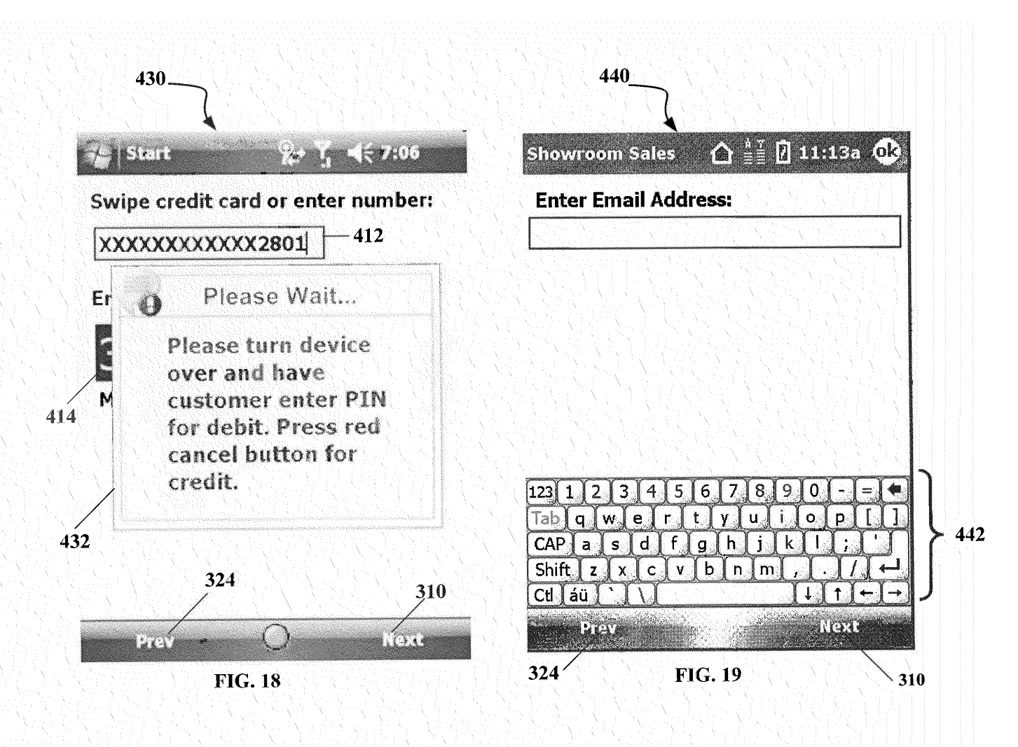

In a preferred embodiment, the mobile computer device 11 is programmed to automatically select the debit payment option over a credit payment option if a card used for payment has debit capability. When a card is swiped, the mobile computer device 11 determines whether it has debit capability by sending the card number to the retail sales management computer system 16 for querying the BIN database 31 to determine the card type. If the entered card is debit capable as well as credit capable, the mobile computer device 11 automatically selects the debit option and prompts the user 12 to have the customer enter his or her PIN for the debit transaction, as shown in FIG. 18. If the customer wishes to pay via the card's credit capability, the customer can press a red cancel button on the PIN entry pad 56 to complete the transaction as a credit transaction rather than a debit transaction.

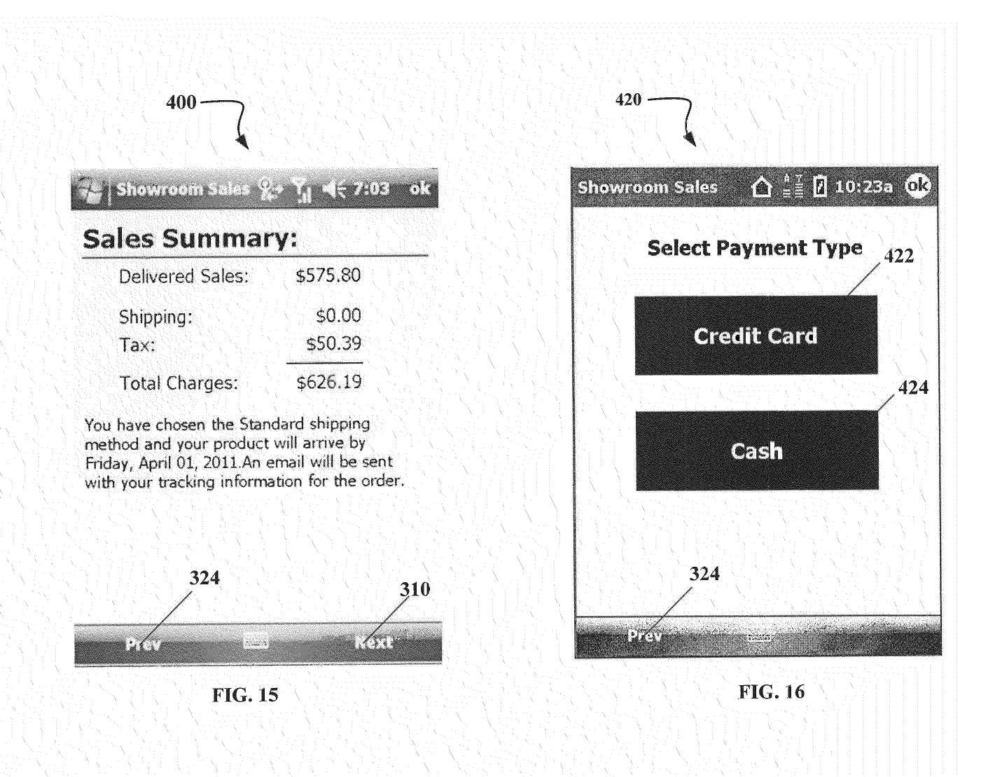

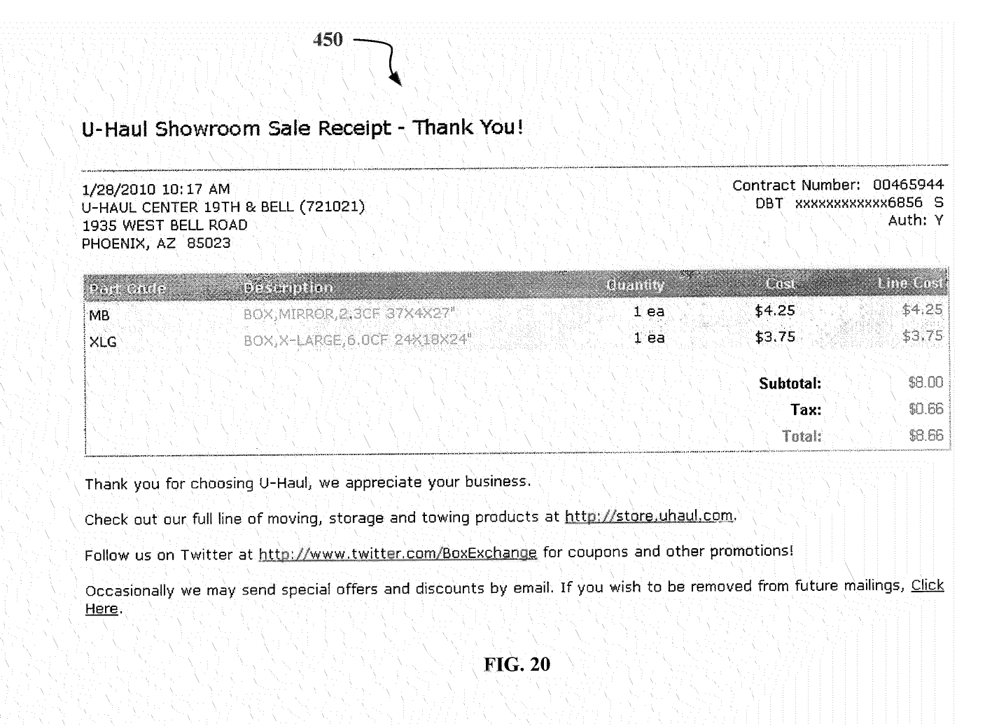

After payment is approved, the mobile computer device 11 displays an Email Prompt page 440 like that shown in FIG. 19 to prompt the user 12 to enter the customer's email address. After the customer's email address is entered, the user 12 can select the Next button 310, which causes the mobile computer device 11 to display a Sales Summary page 400 showing the sales price, shipping charges, taxes and total of the charges, such as in the example shown in FIG. 15. Selecting the Next button 310 on the Sales Summary page 400 causes the mobile computer device 11 to send the transaction information to the retail sales management computer system 16 to process the sale and to send an email receipt 450 to the customer, like the receipt shown in FIG. 20.

Upon reading this disclosure, those skilled in the art will appreciate that various changes and modifications may be made to the preferred embodiments and methods of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for making store sales at a sales location remote from a sales counter in the store, the method comprising:
using a mobile computer device to scan a bar code identifier of a product;
using the mobile computer device to display product information associated with the product identifier;
using the mobile computer device to input a quantity of items to be purchased by a customer;
using the mobile computer device to select a payment type for purchasing the items, wherein the payment type can be selected from the group consisting of cash and card;
using the mobile computer device to read payment card information from a payment card when the customer selects the card payment type; and
prompt the customer to enter a PIN with the mobile computer device when the payment card has a debit capability.
